(19) United States
(12) Patent Application Publication
(10) Pub. No.: US 2024/0160551 A1
(43) Pub. Date: May 16, 2024

(54) COMPUTING DEVICE INTERACTION TRACKING AND ASSESSMENT

(71) Applicant: REWORDLY INC., TORONTO (CA)

(72) Inventors: MATEI VASILESCU, TORONTO (CA); MARIO VASILESCU, TORONTO (CA)

(21) Appl. No.: 18/282,371

(22) PCT Filed: Mar. 16, 2022
(86) PCT No.: PCT/CA2022/050399

§ 371 Date: Sep. 15, 2023

Related U.S. Application Data
(60) Provisional application No. 63/162,239, filed on Mar. 17, 2021.

(51) Int. Cl. G06F 11/34; G06F 40/284; G06Q 30/0217; G06Q 30/0282; G06Q 50/00; G06V 30/10

(52) U.S. Cl. CPC G06F 11/34; G06F 40/284; G06Q 30/0217; G06Q 30/0282; G06Q 50/01; G06V 30/10

(57) ABSTRACT

Method and systems are provided to track and analyze interactivity with content presented via a computing device to measure attention and content consumption. A measure of imputed content understanding can be associated with the measure of consumption. Content comprises one or more sub-content items each having a type (e.g. image, text, video or audio). Items are respectively assigned a minimum time duration for total consumption by a user giving their focused attention, based on an amount and nature of item information. Minimum duration relates to a presentation time length. A credit value related to the total consumption is assignable. Tracking data is stored (e.g. periodically) which identifies the portion of content presented, a duration of presentation, a focus measure and interactivity. A consumption rating per item and as aggregated is determinable. Ratings and rankings are determinable by subject and can be shared and verified. Ratings and rankings can achieve rewards.

### CROSS-REFERENCE

This application claims a domestic benefit, in respect of the United States, and Paris convention priority otherwise, of U.S. Application No. 63/162,239, filed Mar. 17, 2021, the entire content of which is incorporated herein by reference where permissible.

### FIELD

Embodiments of this application relate, generally, to tracking a user's interactivity with digital content such as sub-content items from websites or application programs.

### BACKGROUND

Computing devices such a smartphones, tablets, e-readers, personal computers (PCs), laptops and other devices are commonly used to present content such as one or more items comprising any of text, an image, an audio item or a video item. Content is typically presented via a graphical user interface (GUI) which is displayed via a display device. One or more controls may be provided to a user to engage with the content, for example to scroll over the content, play an audio or video item, select a portion of content, etc. The controls may be operated via an input device such as a touch screen, pointer, keyboard, microphone, etc.

Traditionally, time spent with digital content has been measured for the purposes of assessing media success and related advertising revenue. This required simple, relatively binary assessments, such as whether the content was viewed or not. This resulted in correspondingly simple methods of assessing attention to digital content that barely take into account what a viewer is actually looking at. Traditionally such analysis is performed for the benefit of (e.g. shared with) an advertiser or content provider and not shared with or performed for the user.

Users of the content, content providers and others are interested in tracking and assessing interaction activity with sub-content items, for example, to accurately, reliably and granularly (e.g. on a subject basis) measure and share user engagement and content comprehension.

### SUMMARY

Method and systems are provided to track and analyze interactivity with content presented via a computing device to measure attention and determine a measure of content consumption. A measure of imputed content understanding may be associated with the measure of consumption. Content may comprise one or more sub-content items each having a type (e.g. image, text, video or audio). Sub-content items are respectively assigned a minimum time duration expected for total consumption by a user giving their focused attention, based on an assessment of the amount and nature of the information in the sub-content item. For brevity, the term “nature” is used from time-to-time to indicate the variable complexity or structure of information within a content item. The minimum duration relates to a presentation time length by the computing device. A credit value related to the total consumption may also be assigned. During presentation, tracking data is stored (e.g. periodically) which identifies which portion of the content is presented, a duration of presentation and interactivity with the content. A presentation duration is determined as is a focus measure relating the type of attention given during the duration. A consumption rating for each sub-content item and the whole content is determinable using at least in part the focus measure and duration. Ratings and aggregated rankings are determinable by subject of the content. Ratings and rankings are sharable and, via an interface, are verifiable. Ratings and rankings are useful to achieve rewards.

### BRIEF DESCRIPTION OF FIGURES

FIGS. 1A and 1B are illustrations of computing devices presenting content in accordance with an embodiment.

FIG. 2 is an illustration of a communication network system in accordance with an embodiment.

FIG. 3 is an illustration of a user computing device configured to track interactivity in accordance with an embodiment.

FIGS. 4A and 4B are flowcharts of operations of methods in accordance with an embodiment.

FIG. 5 is a block diagram of a representative computing device in accordance with an embodiment.

FIG. 6 is an illustration of a communication network system in accordance with an embodiment.

FIGS. 7A and 7B is an illustration of a computing device configured to analyze author content and provide annotated author content responsive to the analysis in accordance with an embodiment.

FIG. 8 is a flowchart of operations of a method in accordance with an embodiment.

### DETAILED DESCRIPTION

The description herein details several exemplary embodiments. One skilled in the art will appreciate that it is within the scope of the present disclosure to combine individual embodiments with other embodiments as appropriate.

Embodiments herein show and describe tracking and assessment of interactivity with content presented via a user computing device, such as but not limited to, a smartphone, tablet, laptop, PC, e-reader, etc. A user computing device, in accordance with an embodiment, is configured to perform assessment and tracking functions such as via a browser extension, an application (e.g. components thereof), or publisher plug-in (e.g. to an application website/browser).

In an embodiment, a remotely located computing device (e.g. a server) is configured to communicate with the user computing device to receive various data, for example, user computing device setup data, content identification data, and tracking data; and to compute interactivity measures and per content interactivity rating data.

In an embodiment, the user computing device performs an autonomous content detection operation to validate the content for tracking interactivity and provides, to the server, setup data and content identification data accordingly.

In an embodiment, content comprises a plurality of sub-content items, for example, one or more data items comprising any of text, image, video and audio data. In an embodiment, the server analyses the content and determines, for example, for respective sub-content items, (sub-content) item minimum duration data and (sub-content) item credit data. For brevity, the term “item” is used from time-to-time for a “sub-content item”. Item minimum duration data is responsive to the nature of the content. For a respective sub-content item, item minimum duration comprises a minimum amount of time that the respective sub-content item is to be displayed (e.g. presented) by the user computer device, continuously or in the aggregate for the user to obtain 100% of the item credit (full content consumption). The minimum duration that the sub-content item is to be displayed is the time length to facilitate a measure of content consumption associated with having fully consumed and internalized the content as knowledge, when the user is providing focused attention to the respective sub-content item. That is, with a sufficient focus of attention to understand the content/meaning thereof. Knowledge is imputed from the duration and focus measure—i.e. likely knowledge. The credit given is a consumption credit with imputed knowledge. In an embodiment, focused attention is determined by analyzing interactivity behaviour, which includes, in part, a first scroll rate or range of rates consistent with focused attention in relation to the content (e.g. relative to its nature). Similarly, skimming attention is determined by analyzing interactivity behaviour, which includes, in part, a second scroll rate or range of rates, faster than the first rate or range of rates, consistent with skimming attention in relation to the content. In such a case, the user may achieve a lesser credit value e.g. 50% of the full value when skimming attention is determined.

In an embodiment, tracking data is evaluated to determine interactivity and provides a focus measure, which measures, for respective time periods and for respective sub-content items, a user's attentiveness to the respective sub-content items. In an embodiment, the focus measure is one of a skimming focus or an attentive focus. A rating of engagement with the content in the aggregate is generated using one or more focus measures for each sub-content item, including, per focus measure, the actual presentation duration the item was presented vs the minimum duration. In an embodiment, a percent of the content may comprise the rating e.g. 75% consumed. In an embodiment a credit value is assigned to each sub-content item and the sub-content item credits in the aggregate define a content maximum credit value. In an embodiment with a credit value(s) assigned, the rating may comprise a credit score (e.g. 3 (of a max 4) credits consumed). In an embodiment, the rating is provided for display.

In an embodiment, interim ratings (ratings accumulated on the fly, during content presentation, for example) are provided as the content is presented and tracked via the user computing device. In an embodiment, the content analysis determines a subject for the content and the rating is associated with the subject and presented for display. In an embodiment, the rating and subject are stored in a data store in association with the user. In an embodiment, content identification is also stored. In an embodiment, an accumulation of ratings (e.g. per subject and over a plurality of respective content) is determined for the user providing an aggregated rating or ranking per subject. In an embodiment, a ranking per subject is determined by comparing a user's aggregated rating with the respective aggregating ratings of all other users for the subject.

In an embodiment, individual content ratings or an aggregated ranking (for a subject) may be shared such as via social media or otherwise in association with the user and provided for display. In an example, in the context of a social media website or application, the user's profile may display the users ranking or individual rating. Such display of the ranking or rating may link to an interface to verify such data.

In an embodiment, such individual ratings or an aggregated ranking may be used to order content for presentation on a computing device. For example, where the user provides a comment to content (via a webpage or an application (e.g. a social media application)), the user's ranking associated with the subject of the content is provided and displayed. User rankings for users making comments may be used to order the comments.

In an embodiment, content contribution related activities by a user having an individual rating or aggregated ranking (e.g. for content consumption) are tracked. Contribution related activities that are tracked may include interaction with other users. In an example, an interaction that receives positive feedback is tracked. In an embodiment contribution credits are earned. In an embodiment, corresponding rewards or recognition are earned (e.g. assigned), such as a badge for the user.

In an embodiment, individual content ratings or an aggregated ranking may be used to determine a reward. For example, in an application, a ranking at a particular level or higher may unlock an application feature, provide additional access to other content (e.g. premium content), other applications, provide credits, badges or other rewards for products, services or both, etc.

In an embodiment, where particular content (e.g. a web page) is presented in more than one session to the user, for example, to the user using a same user computing device or to the user using different user computing devices, interactivity is trackable on a per session basis. In an embodiment, the rating for the content is determined using focus measures and respective minimum and actual durations for all sessions. User computing device setup data for each session is useful to determine the respective focus measures and actual durations, for example, because different user computing devices (or even a same computing device) may present a different amount of content at any particular time.

These and other features will be apparent to those of ordinary skill in the art.

Content, in an embodiment, comprises mixed media content including one or more sub-content items such as a text item, an audio item, a video item, and an image item. Content is often organized as a page for display by the user computing device via a GUI such that respective sub-content items are spatially arranged relative to one another. A portion of the whole content (e.g. a part of a page) is displayed relative to a viewport. Sub-content items may be brought within the viewport such as by scrolling. The GUI may provide controls for scrolling or other input activities.

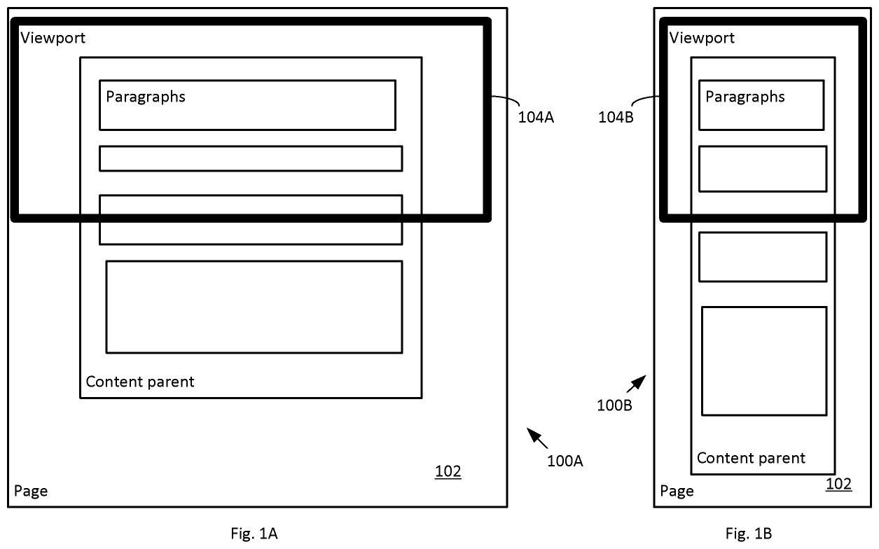

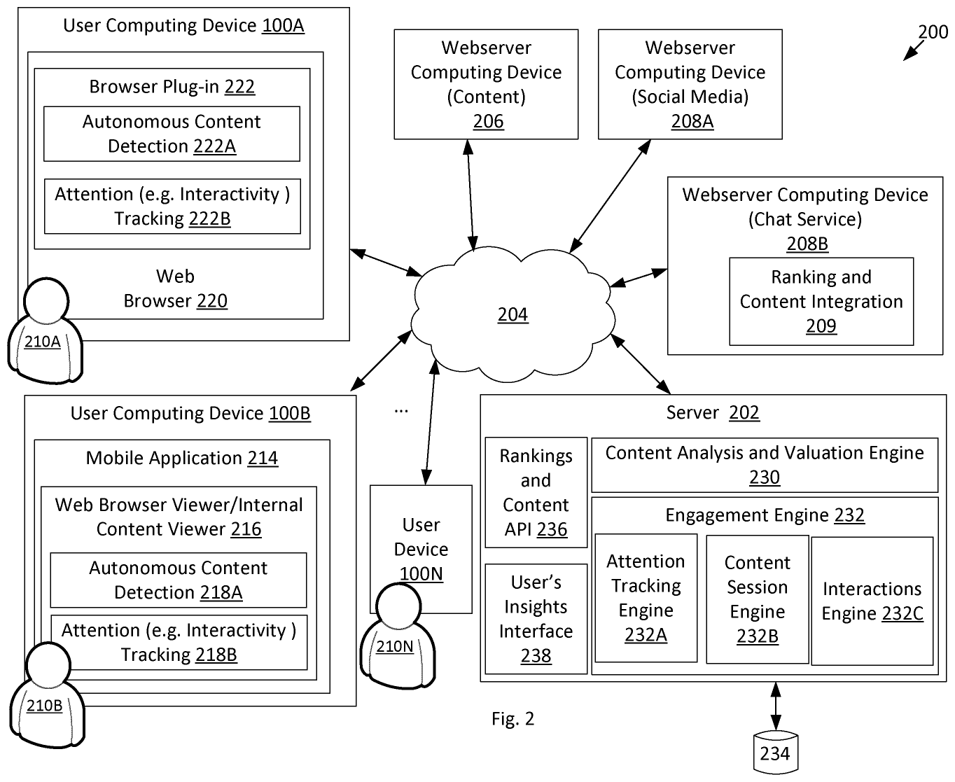

FIGS. 1A and 1B show schematically, representative user computing devices 100A and 100B displaying content 102 on respective display devices (not shown). FIG. 1A shows content 102 on a desktop (100A), while FIG. 1B shows content 102 on a tablet or smartphone (100B). In accordance with an embodiment, user computing device 100A is configured via a browser extension, an application, or publisher plug-in while user computing device 100B is configured via an application, or publisher plug-in. See too FIG. 2.

Each device 100A and 100B presents a portion of the content 102 visible through a viewport 104A and 104B, a viewing region. A viewport is a generally rectangular portion of a display screen (component of the display device) in which the content 102 is displayed. Content 102 may appear differently on different computing devices for example, because each may offer a different viewport. In some instances such as for a video or audio sub-content item, a respective control for the video or audio is displayed, typically within the viewport. Engaging the respective control may initiate play, stop play, advance play forward or reverse, adjust volume, video display size, speed, resolution, etc., associated with the content among other features. An additional output device such as a speaker or communication device (e.g. an output jack a comm. port or a comm. antenna) may be engaged to present audio. Controls may be associated with scrolling within the viewport such as up, down, left, right, page up, page down, swipe, pinch, flick, click, double click, search/find, select, etc. Controls may be keyboard activated, voice activated, gesture activated (e.g. via pointing device or touch screen, etc.) etc. Other controls may take a focus away from the content in the viewport, for example, switching to another interface of a same application (e.g., to another browser tab from a current tab where the content is presented), switching applications, etc.

In an embodiment, interactivity with controls relative to content in the viewport is indicative of attention to the content. Engaging other controls (e.g. outside the viewport) is indicative of inattention to the content. In an embodiment, operations monitor focus in and focus out events that are independent of the viewport but are associated thereto. That is the result of an input that moves a focus out of the viewport is monitored but inputs received while the focus is out are not monitored (e.g. they are ignored). Interactivity while the focus is in the viewport is correlated.

FIG. 2 is a computer network system 200 showing a server device 202 in communication with a plurality of user computing devices 100A, 100B, . . . 100N via a communication network 204. A webserver computing device 206 providing content also communicates via the network 204, for example, with any of the other connected computing devices.

A webserver computing device 208 providing social media content and services also communicates via the network 204, for example, with any of the other connected computing devices.

Server device 202 performs content analysis and facilitates measures of interactivity such as focus measures for content presented to users (e.g. 210A, 210B . . . 210N) by user computing devices 100A, 100B and 100N. As will be described in relation to content sessions below, users need not represent unique individuals. An individual person may be a user of more than one user computing device and be so associated at server 202.

In an embodiment, user computing device 100B provides a mobile application 214 to receive and present content and has a web-browser based viewer 216 or other internal content viewer component to present content (which can include audio (and/or video) content controllable via visible controls, for example) and to facilitate content interactivity tracking and assessment. Viewer 216 comprises one or more features and/or components for including autonomous content detection 218A and attention (or interactivity) tracking 218B both of which are described further below.

In an embodiment, user computing device 100A provides a web browser 220 (a type of application) to receive and present content and has a plug-in 222 to facilitate content interactivity tracking and assessment. Plug-in 222 comprises one or more features and/or components for including autonomous content detection 222A and attention (or interactivity) tracking 222B both of which are described further below. Features and/or components 218A and 218B are similar to features and/or components 222A and 222B

In an embodiment, server device 202 provides a content analyzer and valuation engine 230 (e.g. a software component) to receive setup data and content identification data from user computing devices such as device 100A. Server device 202 provides an engagement engine 232 for example, providing an attention tracking engine, 232A, a content session engine 232B and an interactions engine 232C. Server device 202 is coupled to a data store 234 such as a database. Data stored may comprise user profile data for respective users (210A, 210B . . . 210N), individual rating data per content, aggregated ranking data per subject, interaction rating data, etc., as further described. In an embodiment, server device 202 provides a ranking and content application programming interface (API) 236 to enable other computing devices (e.g. as may be authorized) to obtain data from data store 234. In an embodiment data comprises, for a particular user, the user's ranking information, user's content information (e.g. information about the content the user has consumed for determining the ranking), user's profile information (e.g. which may be set to “public” by the user for sharing). In an embodiment other information is made available that relates to the service provided by server 202. Other information may include aggregated information regarding multiple users, subjects, etc. A webserver or other computing device may have one or more integration components to access the API 236. While an API is described, server 202 may provide another interface type or more than one type.

In an embodiment, server 202 is configured to share data from data store 234. In an example, data such as described with reference to API 236 is shared. In an embodiment, sharing comprises publishing a message via a social media webserver.

In an embodiment, server 202 provides an interface 238 to data in data store 234 where the data comprises insights into a user's use of the service(s) provided by server 202. In an embodiment the interface is a web-based interface, for example, to enable a user to view data in a browser. In example, it is an API or other interface to obtain data for an application executing on a user's computing device. In an embodiment, interface 238 receives respective requests (e.g. defined at least in part from user input via respective user devices) to select the insights (data) to be viewed. Insights may be precomputed and stored to data store 234 or computed, at least partially, in response to requests received via the interface.

In an example, the insights relate to the content the user has consumed using server 202 (i.e. for which respective content attributes have been determined by content analyzer & valuation engine 230 (which attributes can be stored to data store 234) and interaction (e.g. attention paid) with such respective content has been tracked by engagement engine 232 (which attention attributes can be stored to data store 234). In an example the insights relate to content consumed during a (e.g. user selectable) period of time or times such as to evaluate trends. Insights relate to the user's habits as determined from the user's use of the services of server 202.

Data store 234 effectively stores, for each user, a history of the respective user's consumption behaviour, for example, storing the respective content attributes for each content instance in association with the user's interaction or attention attributes generated when the user interacted with the respective content, including credits and awards earned.

Examples of content attributes that can be trended and averaged are political bias, detected mood (of the content), top authors, etc. Examples for attention attributes include average type of focus, average level of completion (such as a measure (e.g. a percentage) of how much of each respective instance of content was consumed), average time spent, average time of day, etc.

Trends and averages on an individual user basis or as aggregated for a group of users can be determined for content attributes, interaction/attention attributes or both. Such trends and averages for a group of users can be determined in respect of the same content items consumed by a respective one of the users, or determined in respect of the same and additional content items during a same time period (e.g. last 30 days), etc. Similar data, such as similar average attribute data, from different time periods can be determined, and presented and/or compared. For example, data for the most recent 30 days can be presented and/or compared along with data from any previous 30 day period. For example, a current 30 day period can be compared to the most immediate past 30 days (e.g. month over month) or to a 30 day period from 12 months earlier (year over year), etc.

In an embodiment, interface 238, for example, can be configured with applicable predefined insight rules, code or other operations that produce the respective insights from respective stored attributes. Respective insights can be associated with predefined value thresholds, value ranges (e.g. establishing good, better and best content consumption), etc., associated with standards of behaviour (e.g. reasonable or advisable behaviour traits). In an example, a standard comprises a maximum threshold of 50% content from “breaking news”. In another example, a standard comprises of a maximum of 50% content that is emotionally charged or of negative sentiment. In an example, interface 238 is enabled to receive a user's definition of a standard (e.g. a percentage of content of a particular subject relative to all content consumed).

Trends and averages for content attributes and attention attributes for a particular user and for a group of users can be compared and contrasted including comparisons between time periods. For example, data from an interaction by a particular user with the content can be compared with data from an aggregate of interactions by a plurality of users. In an example, an insight includes information stating:
“87% of content detected had a negative mood, 21% more than last month, and 37% more than is advisable”; or,
“more than 50% of your attention this month was skimming instead of focused attention, 41% more than last month. Consider making time for more focused consumption.”

Features and functions of webserver computing devices 206 and 208A and 208B are described below herein.

Content 102 such as for presentation by a user computing device may originate from a remote source such as webserver computing device 206. In an embodiment, content 102 is obtained such as by browsing using a web browser (e.g. 220) having a plug-in 222 (see device 100A). In another embodiment, content is obtained using an application (e.g. 214) such as one provided by a content distributer (publisher) having similar components (e.g. a viewer 216) to present content and analyze and track same (see device 100B). In an embodiment, content 102 may comprise a web page of a website, published content for an application, etc. Content 102 is often defined using a mark-up language such as hyper text mark up language (HTML), extendible mark up language (XML), portable document format (PDF), or as an electronic publication (ePub), etc.

In an embodiment, content 102 is validated—it is analyzed to determine whether tracking and assessment is to be performed. In an embodiment, to share computing duties and reduce server burden, content is initially analyzed by user computing device such as device 100A and further analyzed by server 202.

Valid content comprises text and/or mixed-media that together occupy the dominant visible space on the webpage, and that are not part of non-content HTML. For example, content does not qualify (as valid) if it is within an HTML FORM element and/or has e-commerce type HTML elements within its parent wrapper (quantity input, “add to cart”/“buy” buttons, etc.)

For example, for a web page in HTML, autonomous content detection comprises:
Scanning the web page for all “P” and “DIV” HTML elements that have no block (HTML elements are either “inline” or “block”) children (sub elements) and determine which of the two has the most total words. Set this as the “paragraph” element. More than one paragraph element may be identified.
Following paragraph identification, first scanning all paragraph elements and using their coordinates, group them by X position and column width.—Second, scanning all mixed-media HTML elements (video, podcast embed, images), and group them by X position and column width.
Merging text content and mixed media columns data into array of columns. When merging and grouping, allowance is provided for minor variations in X and width for indentation and list bullets.
Sorting the columns of content by word count and/or dominant mixed-media content. If first column (column with the most words and/or mixed media) is substantially longer than next sorted columns, such column is maintained as the primary content. If a page contains shorter form content AND the difference between the total content in the 1st column and the 2nd column is small, send contents of both columns to the server to analyze for content structure to determine which of the two columns is more likely to be the true content column.
If the determined column contains sufficient text, or mixed-media (text, images, videos, podcasts), send contents of the column to server 202 to validate against classification operations described herein below to confirm the content as a whole constitutes a unified/whole piece of content.
If determined to be valid content, determine the lowest common parent HTML tag that wraps the identified content elements (paragraph elements and/or mixed media).
Sending to server device 202 content identification data (e.g. a universal resource locator (URL)) to facilitate association of user and rating data to content analysis and setup data for tracking analysis.

Where content comprises XML, ePUB, or PDF, in an embodiment (e.g. within a browser/plug-in viewer embodiment), the content is converted to HTML and is processed as a web page. In an application-based embodiment, content can be processed in an original format.

A session ID is received from Server 202, in an embodiment, when the content is valid and is used in subsequent communications (e.g. sending tracking data) to distinguish a communication from other communications.

Presentation may vary with viewport size, display characteristics, zoom, etc. In an embodiment, setup data comprises data to determine how the content is presented at the user computing device. For example, the setup data comprises data to determine what particular portion of the content is presented in a viewport, such as the coordinates necessary to map the content and its wrapper within the page and the viewport (e.g. all relevant X+Ys, heights and widths, at the page level, viewport level, and content). In an embodiment setup data includes, page X, Y, viewport X, Y, and for each container positions top, left, right, bottom on page, container height & width, parent element top, left, right, bottom on page, parent element height & width.

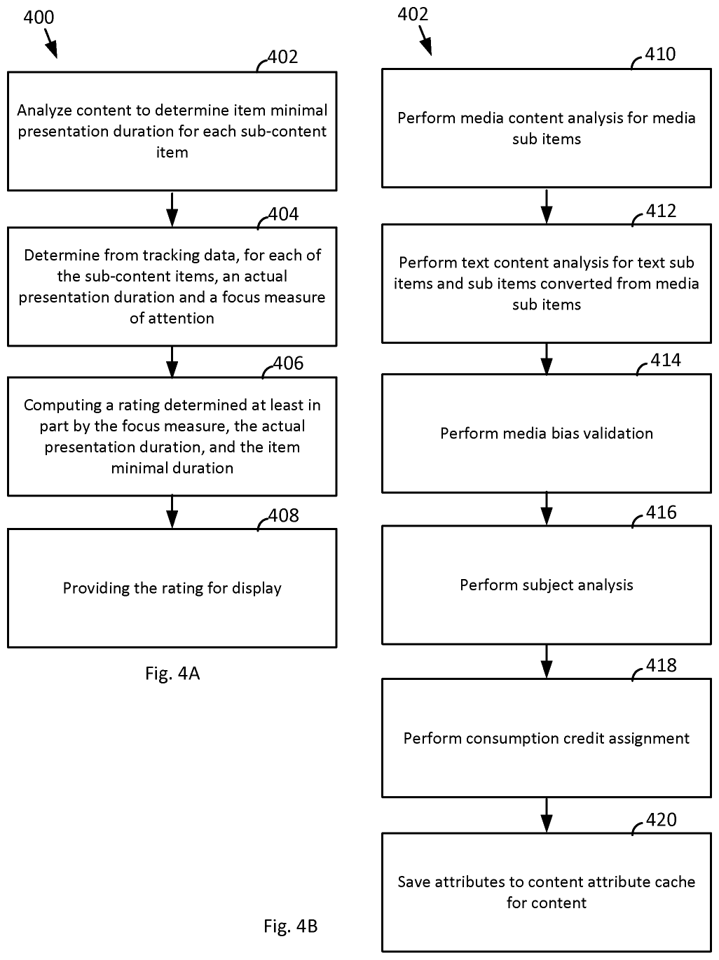

At the server device 202, in an embodiment, operations of content analysis and valuation engine 230 analyze the content for valuation, determining, for example, an information data type, an information amount, an information complexity, an information source credibility, and a subject of the information (e.g. topic), such as is further described herein immediately below and with reference to FIG. 4B.

The information data type is determined. Text is classified as text. Images are analyzed with machine learning processing. If they contain sufficient text and lines (using optical character recognition (OCR)) they are classified as charts or infographics, otherwise they are classified as creative images. HTML tags are scanned for video element tags (YouTube™ (a trademark of Google LLC), Vimeo™ (a trademark of Vimeo, Inc.), HTML5 (e.g. from the World Wide Web Consortium) embedded video, etc.), as well as for audio element embeds (Soundcloud™ (a trademark of Soundcloud Global Limited & Co. KG) embed, podcast embed, HTML embedded audio, etc.) PDF files are converted to HTML and then analyzed as web pages.

The content analyzer and valuation engine 230 processes through content 102 to determine if it is valid content, and breaks down its language, vocabulary complexity, structure, media and media types, length, subject matter, estimate read (consumption) time (e.g. an item minimum duration) both skimmed and carefully read with focused attention (or watch/listen time for video and podcasts). This is performed for each content container and the overall article/content as a whole. If valid content is present, in an embodiment, a total volume of information detected is assigned a value (e.g. a credit) proportional to this volume, so that different pieces of content have respective amounts of information fairly represented. This value can be “earned” by the viewer as a measure of consumed content, as calculated using the interactivity tracked and analyzed for a session. The term “volume” is used to aggregate different information types (e.g. text reading, video viewing and listening, audio listening) and respective consumption durations (time length to read, to view/listen and listen).

In an embodiment, content analyzer and valuation engine 230 comprises the following subcomponents a) a media content analyzer; b) a text content analyzer; c) a media bias validator; d) a subject analyzer; and e) a consumption credit assignor. In an alternative embodiment, fewer subcomponents are present, for example, not including a media bias validator. While described as individual subcomponents, bright line distinctions may not apply and one function or feature may assist with another.

The media content analyzer analyzes any images, video, or audio in the content. The media content analyzer utilizes application programming interfaces (APIs), for example, as made available by content distribution networks or platforms to obtain metadata regarding a particular media item. For example, a video item or audio item may have metadata for a length (e.g. a time length or duration) of the respective video, audio, etc. Media content analyzer may perform image to text conversion, obtain transcripts of video or audio, or perform voice to text conversion. The text so obtained may be further analyzed.

For images, determining how much information there is comprises, in an embodiment, scanning using OCR and depending on the number of words extracted (if any) and their positioning (horizontal, evenly sized characters, existences of rows or columns), identify if an infographic or chart, and assign expected reading based on the similar evaluation that is applied to normal text, including complexity analysis.

For audio or video determining how much information there is comprises, in an embodiment, evaluating to identify the content length and type (audio or video), as well as analyzing the file meta data to extract title, description, and any other hints as to the content type. Where available, APIs return additional information (i.e. YouTube, Vimeo, Soundcloud, etc). Secondarily, machine learning processing is used to analyze words in audio and video. Similar evaluation is performed on the words as is performed when evaluating text as described below.

The text content analyzer analyzes features of the text including vocabulary; complexity; structure; news indicators; and sentiment/tone. Text is analyzed for vocabulary, structure, and word density at the paragraph level, as well as overall. Longer words, words deemed complicated by internal classification data, and percentage of words out of total number of words to be either of these. The complexity determines the expected reading speed. In addition, sentiment analysis for each paragraph or media component (based on text extracted) is conducted to understand if it is likely a more emotionally charged part, which is then deemed to justify more focused attention (slowing down and/or pausing for longer than other pauses). News indicators include elements (e.g. language terms in the content and/or metadata terms) that the content comprises a news article. News indicators, in an embodiment, are used to distinguish news and non-news content and a record in data store in relation to the content comprises a news/non-news flag. An accumulation (e.g. a count of) of news and/or non-news content for a user by subject may be provided, for example, when presenting a user's aggregate consumption data.

The media bias validator performs operations to evaluate the source for bias. In an embodiment, a database, which may be external (not shown) and offers a service is referenced for categorized sources for known bias. Language terms (as a whole or in part) are reviewed for style markers of bias, which may include shouting (CAPS), styles such as excess punctuation, loaded words, etc.

The subject analyzer determines keywords and keyword frequency to compute a subject for the content. For example, in an embodiment, all text (including text in charts and infographics, extracted with OCR), as well as keywords determined from machine learning analysis of images, is then passed through a database of subjects and corresponding keywords. A combined value based on the number of individual keywords found, the frequency of the keywords, and the frequency of certain keyword pairings (i.e. “computer” and “programmer” appearing together) determines the highest matching 3 subjects. In an embodiment, if other users have already been tracked consuming this content, the subject to which the users ultimately sorted the content is considered when evaluating the matching suggested subjects. For example, if multiple users publicly assigned a different Subject to the content than the subject analyzer initially offers, that subject is prepended to the list of suggested matching subjects. If auto-sorting is on, the highest subject is assigned as the subject. In an embodiment, all 3 highest matches are communicated to user computing device for presentation and optional selection/override by the user.

The consumption credit assignor assigns a maximum credit value to the content responsive to the analysis components a)-d), volume of information, in conjunction with above findings. In an embodiment, content from a highly polarized source is assigned fewer credits for the subject detected. In an embodiment, the value assessed for a particular content is chiefly based on the amount of information and the quality and quantity of attention given to that information. A biasing factor is applied in an embodiment, for example, reduced using a factor (e.g. a multiplier) between 0 and <=1, depending on the severity of its bias, where 1 is where no bias is applied. In an example, if it is a known source of constant misinformation and inciting violence, a bias factor of 0 is applied resulting in a value of 0. If it is simply far right or far left bias, it is multiplied down by a factor of 0.5, as an example. Again, so that in the end, when somebody is assessing at a glance, the total credit value is reflective of not just quantity of information, but trustworthy information.

In an embodiment, to enable comparison and referencing by others, a credit is associated with a base line amount of information. For example, 1 subject credit=200 words (including equivalent text for an image) or 60 seconds of audio/video. To earn each subject credit requires sufficient attention for the minimum amount of time associated with the volume of the content. Tracking analysis determines a focus measure and the actual presentation duration. A focus measure of “attentive focus” is required to achieve a full credit for the content over the required minimum amount of time. If the focus measure is determined to be lower, for example, “skimming focus”, only 50% of the value is earned. By way of example, if a content is assessed 4 credits in total value and analysis of interactivity shows 50% duration at focused attention and 50% duration at skimming attention, 3 credits would be earned.

In the respective devices 100A and 100B, web browser 220 and plug-in 222 and application 214 and viewer 216 operate to present content 102 and track interactivity. In an embodiment, interactivity is measured against this content to understand quantity and quality of attention given. Periodically, for example, every 1 second interval, attention tracking component 222B (or 218B) tracks interactivity. Tracking data is logged to a data store, where tracking data comprises a (current) position of the viewport, cursor, as well as clicks, and page blur and focus events. Table 1 shows an example log, having serialized data. In the embodiment, data is logged at 1 second intervals (second). A focus in/focus out is logged as wells at viewport and click positional data.
Second.ViewportY.Focus(I/O).Click.ClickX.ClickY
2.210.1.0.0.0
3.125.1.1.30.50
4.125.0.0.0.0
Table 1

In Table 1, a first row shows that at Second 2, viewport was at 120 pixels from top, page was focused, and there were no clicks. Second row, at Second 3, viewport was at 125 pixels and user clicked with cursor at 30X, 50Y, etc.

The tracking data is useful to determine a rate or speed of presentation (e.g. scrolling of the viewport and thus presentation of the sub-content items). Tracking data also reveals patterns of input suggestive of patterns of user behaviour e.g. for text, skimming versus attentive reading. Speed (scrolling) and pattern analysis, in conjunction with part of content being viewed at that time, determines the focus measure being given, for example, skimming focus or attentive focus relative to the sub-content item.

In an embodiment, periodically, (e.g. at a minimum of 5 second intervals), attention tracking component 222B for device 100A (or attention tracking component 216B for device 100B) sends tracking data logged to server 202. The periodic interval for data logging and sending may be determined to balance data capturing requirements and server load minimization. In an embodiment, the tracking data is processed by attention tracking engine 232A. Attention tracking engine 232A determines the focus measure. In an embodiment any (e.g. incremental) change to the respective user's rating may be determined using the focus measure, for example, comparing the focus measure and actual duration in association with a respective sub-content item with the required minimum time and the credit value assigned to the respective sub-content item.

As noted, content is analyzed and for respective items of content a respective duration value associated with a length of time to comprehend the sub-content item is determined and a respective credit value is associated with the respective sub-content item. In an embodiment, a respective duration value for viewing and/or listening to a media item (e.g. video or audio) is determined relative to the time length of the item. For video/audio that is consumed with playback sped up or slowed down, the duration value is assigned based on the original file's length regardless of the playback speed. In an embodiment, for text based sub-content items, the duration value is determined using an average reading speed based on internal and external study of average reading speeds for a specific language (e.g. English), for both skimming and attentive focus measures, while also factoring in changes due to word density (vocabulary and/or sentence complexity) and emotion. More time than average is associated for text that is complex or comprises emotional sentiment. Various readability tools and assessment methods may be used and/or adapted for use to determine the duration. For example, a known assessment method is the Gunning Fog Index Formula: 0.4[(words/sentences)+100(complex words/words)], where complex words are those having three or more syllables not including common suffixes (such as -es, -ed, or -ing) and ignoring words that are proper nouns, familiar jargon, or compound words.

In an embodiment, a respective user's assessed reading rate is used. In an embodiment, an interface is provided to enable a user to optionally “calibrate” the tracking by going through a script that more accurately determines their personal reading speed and habits, for personalization. For example, a script is read by the user and an average words per time period (e.g. seconds or minutes) is calculated. The script may include complex text and/or emotional sentiment. More than one script or more than one calculation of average words per time may be determined.

Attention tracking data is evaluated to determine respective actual presentation durations (lengths of time) that respective sub-content items are presented by the respective display device for a respective user. In an embodiment, time stamp value in logged tracking data is used. Other output devices associated with the computing device such as a speaker or audio output may also be involved. The lengths of time need not be continuous in that the presentation of a respective sub-content item may be interrupted by a presentation of another sub-content item (e.g. due to scrolling, moving the view port to another item) or inactivity such as moving away from the content (e.g. to another tab or application) and moving back. Presentation time per se associated with the presentation of a sub-content item is not wholly determinative of attention. In an embodiment, interactivity actions (e.g. content/viewport position and inputs to the computing device, particularly those associated to the content) are analyzed to associate a behavioural component to the tracking. In an embodiment, attention tracking seeks to authenticate patterns of interactivity.

In an embodiment, attention tracking analyzes (e.g. as determined from the tracking data) the visual position of the content, and the aggregate time that each component (e.g. respective sub-content items) stays in the viewport, combined with cursor/mouse position/activity, as well as attention behaviour data on typical user behaviour. Such attention behaviour data in an embodiment comprises gathered research data showing average user behaviour based on aggregated attention data across all content. A component of such data comprises a scroll rate. Attention behaviour data on typical user behaviour is stored to data store 234, in an embodiment. All of these data points are combined and compared. The viewports position and scroll rates are compared against the specific content at each point. For example, a user may scroll more slowly or pause for longer on an infographic or a dense image, or over text that is structurally more complex than the rest of the article, or that is identified to be the most emotionally charged per prior sentiment analysis.

In an embodiment, mouse (pointing device)/cursor position is monitored, as well as clicks, and other content interaction such as highlights (e.g. click and dragging across simple text). For video and audio media embedded directly in the page (e.g. not using iframes), player buttons are identified and processing operations identify if and where the user skips ahead (or back) while listening/viewing.

In an embodiment, interactions from the tracked data characteristic of a user's behaviour is compared against: 1) the content analyzed and its expected attention requirements, for example, scroll rate per respective sub-content item; 2) the user's own history of behaviour (e.g. as stored in data store 234, including logged behavioural data, primarily scroll rates relative to the prior consumed content), including average reading speed, and reaction to different types of text and media; 3) historical data of all other sessions on that specific content (e.g. as stored to data store 234); 4) historical data of average behaviour on similar kinds of content in both subject and content mix (e.g. as stored to data store 234) including scroll rates determined from anonymized logging and averaging other user behaviour; and 5) proprietary research-based data (e.g. as stored to data store 234) that suggests certain expected ranges of behaviours for a given content type/structure.

This tracking is managed across devices and content sessions in association with the content session engine described further below. In an embodiment, session identifiers are used for respective tracking data. Content will have different coordinates (e.g. generally, positions related to the actual display device used) for different devices due to different display resolutions, viewport sizes, etc. In order to correctly grant credits for the content consumed, each session is isolated to its specific device (e.g. using setup data), and the aggregate portions of content consumed across all content sessions for a same user on same content determines the overall attention to that content and therefore overall percentage of content determined to be consumed and average quality of attention given (e.g. between skimming and focused).

In practice when interacting with a display device including the content, a user may spend time on a portion of a page that is not content, for example spending more time on non-content and less on a portion that is content. Thus presentation of content within the viewport is not wholly determinative of time spent. Tracking of scrolling, mouse, and overall interactions must correlate to the type of content identified on the page. If the attention and interaction given does not match the content in view, the content is determined not to have been consumed (or not consumed fully, in the case of identifying skim reading/viewing (i.e. skimming attention)).

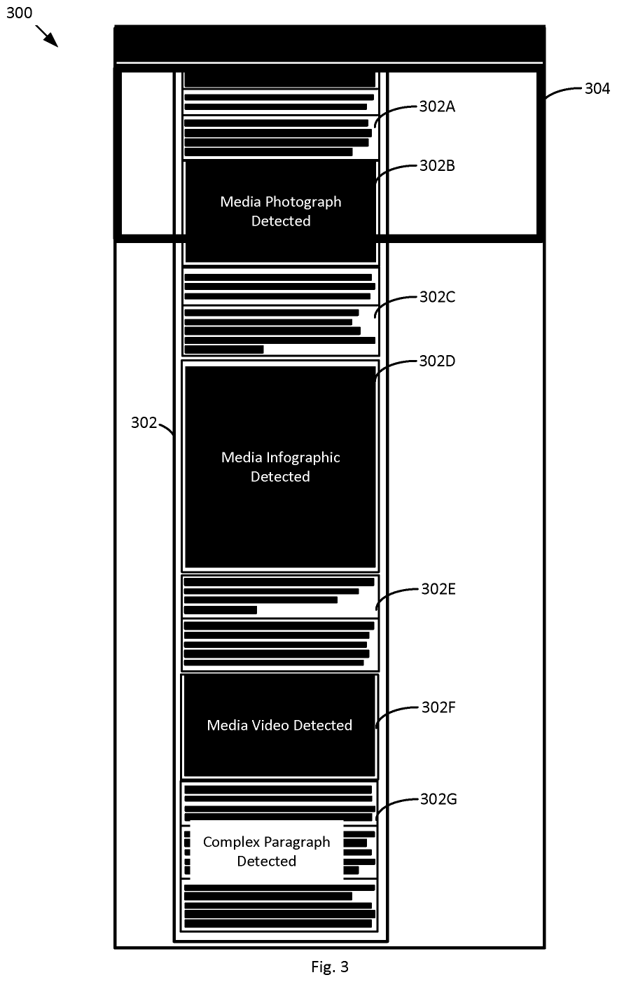

An example content session may assist understanding. FIG. 3 is a block diagram of a user computing device 300, in accordance with an embodiment. User computing device 300 is representative of one of the devices 100A-100N. User computing device 300 presents content 302 in the form of a page comprising a plurality of sub-content items 302A-302F including text items (302A, 302C, 302E and 302G), at least one of which is a complex paragraph (302G) and a plurality of media items, including a photograph image (302B), infographic image (302D) and video (302F). There is illustrated a viewport 304 within which portions of the content are presented. Viewport 304 is notional in that the viewport is not actually displayed in such manner by the user computing device 300 as is understood to a person of skill in the art. In the embodiment, setup data, and content identification data was previously communicated to server 202. Content 302 has been analyzed and valuated by content analysis and valuation engine 230. The subject is determined to be INTERNET & TECHNOLOGY in the present example.

As content 302 is presented, tracking data is logged (e.g. periodically) by user computing device 300. Logging is performed, for example using a plug-in or application component associated with the browser or application presenting content 302. The tracking data is provided to server 202, for example also periodically but usually less frequently than it is logged (at each interval of transmission of tracking data to server 202, all logged tracking data that was collected since the previous transmission is sent).

Based on the tracking data that logs interactivity and presentation related data, the user's patterns of attention are analyzed. In accordance with a premise, a user should be moving at a speed, and pattern, that is consistent with human reading speeds for focused attention or skimming attention for content of this nature.

For example, reading with an attentive focus would not be attributed from the tracking data analysis where the data indicates the presentation (e.g. viewport location as logged) skips to the bottom of the content quickly, and moves erratically up and down the page thereafter. Getting to the bottom per se is not indicative, because the rate (e.g. a scroll rate) was too fast. The movement back up and around the page also does not count because it is at speeds and patterns that do not match the consistent, approximately similar intervals and movement of an attentive human viewer for content of this nature. If the erratic movement is nonetheless consistent with at least partial comprehension for content of this nature, the focus measure is assessed to be a skimming attention measure during this period and associated with the respective content in the viewport.

For example, reading at one of these focus measures would not be attributed should the data indicate movement over the infographic at a speed (e.g. a scroll rate) that does not match the amount of information detected inside it using content analyser and valuation engine 232.

In the embodiment, content analyser and valuation engine 232 determines that the video has 5 minutes of content. For example, for tracking data that shows the viewport presenting the video for 2.5 minutes and some clicking activity representative of attention, a focused attention measure is determined. In an embodiment, clicking activity representative of attention may comprise clicking the “Play” button on the media container and then pressing “Stop Play” after 2.5 minutes. The actual presentation duration vs the item minimal duration (for full credit) is 50%. Thus for this sub-content item, only 50% credit is earned.

In the embodiment, the combined focus measures and sub-content item valuations show, when the session finishes, focused attention to 42% of the content, and skimmed attention to another 22% (applies only to text). According to the volume of information that was available overall in the content, it is given a proportional value, which represents the value a user would have “earned” had they paid close attention to all of it. In an embodiment, 1 credit is assigned per 200 words or equivalent. Other credit assignments may be used. The percentages (per focus measure and skimmed measure) are multiplied with this full potential value, and the result provides a rating value that represents the quantity and quality of attention the user gave to this content (and its associated subject).

During the session, in an embodiment such as in respect of user 210A, server 202 (e.g. attention tracking engine 232A) sends to plug-in 222 an updated rating (e.g. an interim rating until the presentation of the content and interactivity is completed) for the content as a whole. In an embodiment the rating is a percentage (%) of the maximum credit value determined by the server's content analysis and valuation operations. The percentage may be represented numerically, graphically or both. For example a radial graph may be used. As the percentage increases, a corresponding quantity of the radius of a circle is displayed or highlighted. In another embodiment a shape such as a circle is filled corresponding to the percentage of total available information value earned on the content by the viewer. The graphical representations may comprise icons. Icons may be associated to controls which link to an interface to obtain further information, for example, information associated with a user profile, subject, content, publisher, etc.

In an embodiment, content analysis determines a subject for the content and the rating is associated with the subject. The subject is provided such as for display. The subject may be represented as text or a graphic (e.g. icon or other). In an embodiment, the rating and subject are stored in data store 234 in association with the user (e.g. a user profile). In an embodiment, content identification is also stored in association with the user. For example, every session (e.g. presentation of content where the content is validated and interactivity is tracked) identifies the URL for the content. In an embodiment, the URL is normalized (e.g. non-essential parts from the end of the string, such as session trackers, ad identifiers, etc. are stripped away). The normalized URL is stored with the session, and all references/displays of the session in the system link back to this URL. In an embodiment, interactivity behaviour data is stored in data store 234 in association with the user providing a history of behavior with content data types. Interactivity behaviour data may include determined scroll rates per sub-content type. The sub-content type may be associated with a complexity measure, sentiment measure or other characterization to provide more data granularity for the user.

In an embodiment, an accumulation of ratings (e.g. per subject and over a plurality of respective content) is determined for the user providing an aggregated ranking per subject. In an embodiment, a user's credits (consumption rating) per subject are summed. The total is compared to summed consumption ratings for all other users having ratings for the same subject. An aggregated ranking may be determined by ordering the summed ratings e.g. ranking X out of Y users. An aggregated ranking may be associated with a label, for example, associated with a percentile or a consecutive group of percentiles e.g. top 30 percent, top 10%, top 1 percent, etc.

In an embodiment, data from data store 234 such as individual content ratings or an aggregated ranking (or more than one for different subjects) may be shared such as via social media (e.g. via webserver computing device 208A or 208B), communication such as email or otherwise in association with the user and provided for display. An example of a social media service that may be offered by device 208A includes any of FACEBOOK™, (a trademark of Facebook, Inc.) INSTAGRAM™ (a trademark of Instagram, LLC), REDDIT™ (a trademark of Reddit, Inc.), TWITTER™ (a trademark of Twitter Inc.) and LINKEDIN™ (trademark of LinkedIn Corporation), among other services.

In an example, such as in the context of a social media website or application, the user's profile on the social media website is associated with a display of the user's ranking(s) per subject or individual ratings. Such display of the ranking or rating may link, such as by hyperlink, to an interface to verify such data. For example, the interface may be provided by server 202 or another server such as the social media server (e.g. computing device 208A) that makes available at least some of data stored in data store 234 (or another) to verify the claimed ranking for the user. Such an interface may provide a knowledge profile for the ranked user.

In an embodiment, the offered data is granular and a user's ratings by content is provided. For example, in an embodiment, server 202 stores, in association with a user's profile, and for each respective content (e.g. a page of sub-content items), a value that represents the volume of information given attention by the user (e.g. a (consumption) rating), the subject, and an attention measure related to the interactivity, for example, indicating how the content was interacted with. The attention measure may be one of “started”, “partially read” “read” or “skimmed”. In an embodiment, these attention measures are determine in response to how many credits have been earned relative to the total available for that URL, e.g. to identify if the user had started, earned partially, or if they consumed all the content, if it was done so fully or skimmed. In an embodiment server 202 further stores associated to the user profile, a total volume of information given attention across subjects (i.e. consumption credits), including value earned through contribution credits by addition of value associated to the content, which may include appreciation from others for the user's contribution as further described below with regard to interactions engine 232C.

The interface may provide an explanation of the rating and ranking service, including any media bias characterization or factoring that affects ratings and, ultimately, rankings as may be applicable. The interface may provide a control/offer to test and/or sign up to the attention tracking service offered by server 202.

Thus, in an embodiment, an interface to a user profile showing granular user data including consumption related data by content permits an observer to verify with particularity the user's ranking and ratings. Such an interface enables an observer to evaluate which content was verified to have been consumed (with its label of how much consumed). In an embodiment, for example, via an applicable public/private setting, a user may permit or not other observers to view the granular user data. In an embodiment, the public/private setting is granular and related to specific content. By way of an example, a user might have 90 credits in POLITICS, but only 8 of 15 articles that earned the user these credits on the subject are shown publicly via the interface.

In an embodiment, the interface (or a related one) enables the observer to test the attention verification capabilities themselves in a provided example.

In an embodiment, a ranking or a rating may be communicated such as a portion of a user's signature for a communication such as an email. A link may be included to an interface as described in relation to social media sharing, which interface provides a service to explain and/or verify the rating or ranking, register to become a user, etc.

In an embodiment, individual ratings or an aggregated ranking may be used to order content for presentation on a computing device. For example, where the user provides a comment to content (via a webpage or an application (e.g. a social media application)), the user's ranking associated with the subject of the content is provided and displayed. User rankings for users making comments may be used to order the comments. In an alternative embodiment, via integration with an external chat platform such as DISCORD™ (a trademark of Discord Inc.), SLACK™ (a trademark of Slack Technologies, Inc.), or REDDIT, a user's rankings or underlying subject matter data is similarly presented alongside comments they post on these platforms. In such an integration, an overall ranking of users or subject matter activity can also be published on the platform's discussions at regular intervals.

Device 208B shows a ranking and content integration component 209 for communicating via API 236 to obtain data from data store 234. In an embodiment, device 208B is provided with user identification data for the service provided by server 202 (e.g. stored in association with the same user's profile data for the service offered by device 208B. When the user of device 208B publishes a comment or other content via device 208B, the device 208B, using user identification data for the service of server 202 and API 236, requests ranking data for the user. In an embodiment, the ranking data for the user relates to a subject that is also the subject of the comment or content published via device 208B, where said content can be (or can include) a link(s) to external content (content hosted on another server/device), in which case, where possible, that content is also analyzed to determine the applicable subject. While an integration component is shown only with respect to device 208B, social media services (e.g. offered by device 208A) may have a respective integration component for similar uses.

As noted, a particular content (e.g. page) may be consumed in more than one viewing/presentation session. In an embodiment, server 202 utilizes a content session engine 232B to enable assessment of interactivity with particular content using more than one presentation session to a same user associated to the session. In an embodiment, user data is associated to one or more user computing devices. For example, user identification data (e.g. a code) associated with a user profile maintained in data store 234 of server 202 is provided by plug-in 222 (or application 214/viewer 216) in association with setup data, content identification data and tracking data. When a respective user initiates a content presentation, an entry is stored in data store 234 in association with the user and the content identification and thereafter via tracking operations and rating operations, rating data is accumulated for the content. A user may stop a presentation, which stops the logging and processing of tracking data. The user may thus have a “partial” rating for the content, where partial means that the rating reflects presentation of the content during only some of the total sessions such as a first session of two sessions. The user may reinitiate a presentation of the same content. Server 202, for example, via session engine 232B, may determine that a prior session exists for the same content. Utilizing setup data and tracking data for the current session (e.g. a second session), server 202 determines rating data and accumulates it to the prior partial rating. In this manner, a same user may switch user computing devices between sessions (which need not be limited to two sessions) and still accumulate a rating for a same content. Thus, in an embodiment each session contains its own coordinates for content and interactions (e.g. related to the setup data). Credit overall may be achieved by normalizing and aggregating content consumption across sessions on specific content.

In addition to consumption related tracking and rating/ranking services, in an embodiment, there is provided a service to track and rate a user's content contribution related activities. In an embodiment, content contribution related activities by a user having an individual rating or aggregated ranking are tracked. Content contributions may be shared with recipients. In an embodiment, reactions of recipients to such contributions are tracked and evaluated, for example, to determine a contribution credit for the user who made the contribution, as described further.

Content contribution related activities may include recommending the content; reacting to the content (e.g. voting, favouriting, etc.); adding the content to a collection of content; sharing the content; adding notes; and writing a summary. In an embodiment, a user who consumes the content may input notes and store notes (e.g. associated to the content via its URL and stored in data store 234 or another). The contribution may be linked with the user's profile (e.g. via an entry in data store 234). Any of the content contribution related activities may be linked in the user's profile of data store 234. Any of the content contributions may be made available to recipients (e.g. individuals), for example, different from the user or the server 202, etc. and may be made available in association with the user's profile, and subject ranking. In an embodiment, the content contribution related activities may be performed on or via a social media site or social media application. In an embodiment, the content contribution related activities are performed on or via a non-social media site or application such as a web site or application providing content distribution from a content publisher.

In either of these embodiments where content contribution related activities and interactions therewith are sourced, the content contribution related activities are shared or otherwise made available to other users (e.g. recipients) of the social media or non-social media content distribution. One or more of such recipients, via respective user computing devices, may interact with a content contribution related activity. For example, a recommendation may be taken and the content viewed. The recommendation may receive positive feedback. In an embodiment, the interaction may be positive feedback on the ranked user's comment or notes. In an embodiment, the server determines a contribution credit for the user in response to evaluation of a positive rated interaction by a recipient. In an embodiment, a contribution credit may be earned for a content contribution without regard to any interaction, though this may not be preferred.

In an embodiment, server 202 provides interactions engine 232C that monitors interactions with the content contribution related activities. For example, server 202 stores a record associated with the user profile in data store 234 of content contribution related activities for each content. A public interface providing access to user ranking data provides access to content contribution related activities, for example, providing a link thereto to view the activity. In an example, the link may include a link to a user's social media page or username/account on a social media site or a non-social media site that is the source of the content contribution related activity.

In an embodiment, interactions engine 232C receives interactions data from a server that is the source of the content contribution related activity, which may include interaction with the contribution by another user. Such a source may comprise the social media server where the other user interacted via a site or application or a non-social media server where the other user interacted via a site or application. In an embodiment, the source may be server 202, for example, should it make an interface available to a user to input notes associated with a consumed sub-content item. In an embodiment, the interaction data is processed and contribution credits are earned and provided for display, for example via a user profile or otherwise.

In an embodiment, the server may be configured to perform operations (e.g. of a method) comprising: determining a content contribution by the user related with the content; defining a content contribution rating responsive to the content contribution and providing the content contribution rating for display. In an embodiment, the server may be configured to perform operations (e.g. separately or in addition to the above operations for content contributing ratings) comprising: following a making available of the content contribution to a recipient, evaluating an interaction to the content contribution originated by the recipient; and define a content contribution rating or an update thereto responsive to the interaction. The contribution rating may be made available in association with the user's subject ranking and/or an interface to verify the user's subject ranking for any of consumed content and content contributions.

In an embodiment, individual content ratings or an aggregated ranking (each being content consumption related) may be used to determine a reward. In an embodiment, individual content contribution ratings or an aggregated ranking may be used to determine a reward. For example, in an application, a ranking at a particular level or higher may unlock an application feature, provide additional access to other content (e.g. premium content) or other applications, or provide credits or other rewards for products, services or both, etc.

Thus in an embodiment, a website owner is enabled to automatically assign a reward based on attention given by a user on a piece of content or in aggregate on a subject. A user's verified quantity and quality of attention toward a subject earned can be aggregated across subjects, URLs, or other filtering criteria. If a reward is assigned for reaching a value threshold for a given subject, URL (web site), or other filter, the user is automatically granted that reward when the system has granted the required value (e.g. earned the appropriate number of subject matter credits based on whatever relative scoring system is assigned). In other words, as the user earns the subject matter value with their attention, the system keeps track of the total value earned. When the total earned within a specific criteria (subject, URL, etc.) meets a reward threshold, that reward is given.

Thus, a website or application owner is enabled to set certain rewards or access based on a user's attention to content. By way of examples: if the user pays close attention to at least 60% of a page, they can access the discussion section; if a user pays attention to a certain aggregate volume of information for the subject “Business”, the user gains access to a special discussion, or gets featured on the front page of the site, or earns a special prize from a sponsor, or earns a badge or certificate, all related to “Business”.

By way of example, if a user has paid close attention to at least a certain aggregate volume of content on a subject from a content publisher (e.g. an online magazine, newspaper, podcast, etc.), the user is provided a discount to purchase a product or service.

FIGS. 4A and 4B are flowcharts of operations 400 and 402 of respective methods in accordance with an embodiment. In the context of FIG. 4A, operations at 402 analyze content for presentation by a computing device to a user. The content comprises at least one sub-content item. The analyzing determines, for each sub-content item, an item minimal duration for presentation on a user computing device. FIG. 4B describes an embodiment of operations 402 in further detail as set out below.

At 404, operations determine from tracking data, for each of the sub-content items, an actual presentation duration and a focus measure of attention. The tracking data is generated in response to user interactivity with the computing device during presentation of the content and the tracking data comprises content positional data and interactions with the content from inputs received. In an embodiment the tracking data is received from the user computing device.

At 406, operations compute a rating determined at least in part by the focus measure, the presentation duration, and the item engagement duration. At 408, operations provide the rating for display.

Operations 402, which can be performed at least in part by content analysis and valuation engine 230 such as earlier described herein, are described with reference to FIG. 4B. At 410, media content sub items are analyzed. Each sub item is converted to produce text (e.g. using audio to text, image to text, etc.) Video and audio data are analyzed (e.g. for duration, etc.). At 412 text sub items (including converted media sub items) are analyzed such as for vocabulary, complexity, structure, news indicators, sentiment and tone. At 414, media bias validation is performed. External databases can be referenced to judge bias. Polarized or loaded language is detected.

At 416, operations perform subject analysis, which in an embodiment uses keyword frequency. At 418, operations perform consumption credit assignment. A volume of information is determined that is responsive to determined time duration for the content and its complexity and structure (e.g. nature). Bias, in an embodiment, is used such as a weighting factor, to reduce credit assignment. A highly polarized source can be worth fewer credits than comparable volume of information from a neutral source.

At 420, operations save content attributes of the content determined by the engine to a content attribute cache (e.g. in data store 234).

Operations 400 may define a method herein in accordance with an embodiment. In an embodiment, item minimal duration comprises an amount of time required by an ordinary person to consume (e.g. visually and/or aurally) the respective sub-content item using a focused attention, based on an amount and nature of information in the sub-content item. In an embodiment, the rating shows likely knowledge of the user in relation to verified consumption of the content. In an embodiment herein the method comprises determining a subject for the content (for example at 402); associating the rating with the subject (e.g. at or after 406); and providing the subject for display with the rating (e.g. at or after 408). The method may comprise accumulating the rating with past ratings associated with the subject to determine a ranking for the subject and providing the ranking for display. In an embodiment, at least one of the rating, past ratings and ranking are stored in association with the user and the method comprises providing an interface to verify at least one of the rating, past ratings and ranking of the user. In an embodiment the method comprises providing the ranking to share via social media or other method of making available to another recipient or service. When shared, the ranking can be associated with a link to the interface to verify the ranking of the user.

In an embodiment, the method comprises at least one of: associating a reward to the rating and providing a service according to the reward; and associating a reward to the ranking and providing a service according to the reward.

In an embodiment of the method, the analyzing step may process the sub-content items by data type to determine the item minimal duration. For example, i) for a video or audio data type, processing comprises determining a play back length and applying a video or audio factor to the length to determine the item minimal duration; ii) for an image data type, processing comprises using image processing to determine whether the image is an infographic, comprising text and processing the text as a text data type; and iii) for a text data type, processing comprises determining text length and text complexity, and optionally any of text sentiment and text bias and applying one or more text factors to determine the item minimal duration.

In an embodiment, the method comprises receiving the tracking data, the tracking data defined during a presentation of the content via a display device to the user. In an embodiment, defining the tracking data comprises logging the tracking data periodically.

In an embodiment, tracking data comprises logged data for: 1) the viewport; and 2) any interactivity in the viewport, where the logged data is associated with a timestamp. And, to determine a focus measure comprises: determining which sub-content item is presented in the viewport; and determining a behavioral measure associated with a scroll rate for the sub-content item presented in the viewport.

In an embodiment, the content is presented in at least two separate sessions either by the same computing device or a different computing device. In a multi-session case, operations that perform tracking data determination are performed for respective tracking data for each separate session responsive to a setup of the computing device used for the separate session; and operations that compute a rating determine a partial rating for the first session and adds to the partial rating for each separate session.

In an embodiment, operations that perform tracking data determination utilize setup data of the user computing device with which to determine that a particular one of the sub-content items is actually presented and the actual presentation duration thereof.

In an embodiment, the method comprises processing the content to verify the content is valid prior to performing content analysis and tracking steps, etc.

In addition to determining rating related to consumption of content such as described in relations to the method embodiments, content contribution is also measured. In an embodiment, the method comprises determining a content contribution by the user related with the content; defining a content contribution rating responsive to the content contribution and providing the content contribution rating for interaction. In an example, the method comprises following a making available of the content contribution to a recipient: evaluating recipient interaction to the content contribution; updating the content contribution rating responsive to the interaction. In an embodiment contribution rating is made available in association with the user's subject ranking. In an embodiment, the content contribution in association with the content comprises, by the user, any of: recommending; reacting; commenting; adding to a collection of content; sharing; adding notes; and writing a summary.

In an embodiment, content comprises any of a web page or an electronic document. In an embodiment, the analysis at 402 analyzes embedded and/or linked sub-content items therein (e.g. linked via URLs, etc.)

In an embodiment, the method comprises determining (e.g. at 402) for each sub-content item a credit value and further determining (e.g. at or in association with operations at 406) the rating in association with a total credit value of all sub-content items.

It will be understood that operations 400 can be performed for a plurality of content (e.g. different content) and for respective interactions with the plurality of content. The operations (when repeated) store content attribute data for each content of the plurality; and, for each user interacting with respective ones of the content, store, in association with the content attribute data, interaction attribute data for each interaction. This respective content attribute data and interaction attribute data can be stored to data store 234 and it can be useful for providing insights (e.g. for respective individual users) and, as later described, for optimizing new content.

Thus, in an embodiment, an interface is provided to obtain insight data responsive to the content attribute data and interaction attribute data. The insight data can be for a particular user based on the particular user's interaction with the content. In an embodiment, the insight data provides a comparison to insight data for an aggregate of interactions with the content by a plurality of users. The insight data can be in the form of trend data for a period of time.

A computing device, in an embodiment, is configurable to perform any of the method embodiments herein. A non-transitory storage device (e.g. one or more) is configurable to store instructions which instructions when executed by a processing unit of a computing device configure its operations, for example to perform any of the method embodiments herein.

Various server operations described as being performed on a server computing device may be configured for performance on a user computing device. Results may be provided to a server for storing and sharing, etc. In an embodiment, server 202 may provide access to data store 234, for example, to enable a user device to access data to analyze content (e.g. similar to 402) or determining a focus measure (similar to 404), as an example.

In an embodiment, content validation operations described in relation to performance by the user computing device may be performed on server 202.

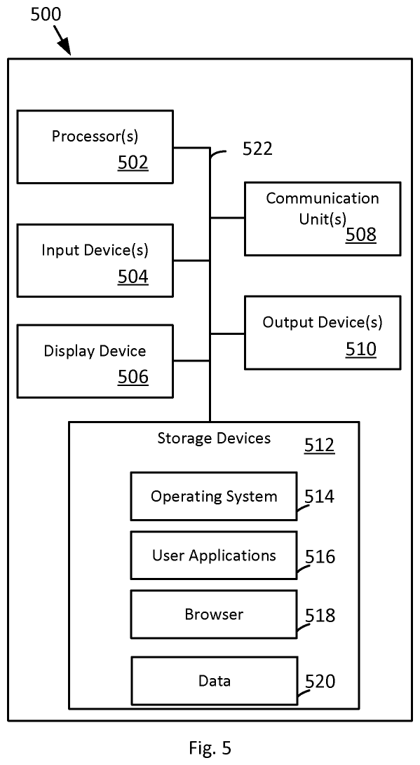

The various user and server computing devices shown herein can comprise a device 500 as illustrated in the block diagram of FIG. 5 in accordance with an embodiment or in a similar configuration as will be understood to a person of ordinary skill in the art. Device 500 comprises a processing unit (e.g. processor(s) 502 (for example a microprocessor, FPGA, ASIC, logic controller, or any other appropriate processing hardware), a storage device 512 (e.g. non-transitory processor-readable storage medium, such as memory, RAM, ROM, magnetic-disk, solid state storage, or any other appropriate storage hardware) storing instructions which when and executed by the processing unit 502 configure the computing device to perform operations for example to provide the functionality and features described herein. Computer program code for carrying out operations may be written in any combination of one or more programming languages, e.g., PHP, python, Javascript, etc.

Storage devices 512 are shown storing an operating system 514, applications 516, browser 518 and data 520 as examples of stored components and data. Computing device 100B, for example, can comprise an application 214 as one of applications 516, where the application 214 comprises an in-app web-browser (see FIG. 2). A server may store different applications and data than a user computing device, for example.

Computing device 500 further comprises input device(s) 504, display device 506, communication unit(s) 510, and output device(s) 510.

Communications unit(s) 510 are configured to communicate via a network such as network 204. These units may communicate in a wired or wireless manner, for example, using applicable protocols and standards.

Depending on the form factor, as an example, the components of the computing device may be integrated as a single unit or may comprise multiple units (e.g. separate units may comprise and be coupled together—a computing unit, a display device, one or more input devices, output devices, etc.)

### Content Optimization

In an embodiment, a content author can provide an instance of the author's content (e.g. comprising one or more sub items) for analysis and receive optimized content in reply, which can comprise annotated content including content suggestions. The author's content is analyzed by the content analysis and valuation engine 230 to create content attributes for each of the sub items and the content overall. The attributes for the author's content are compared to an aggregated version of granular data of how other users have previously consumed other content. In an example, the other content is other instances of the author's content. In an embodiment the other content comprises instances of other author's content (which may include or exclude other instances of the author's content such as by using filters). Responsive to the comparison, operations automatically suggest how the author's new content differs from the aggregate content data, and what changes may be beneficial. Examples of suggestions can include, spacing to break up paragraphs, adding or removing headings, additions of different media types, length adjustment, tone adjustment, etc.

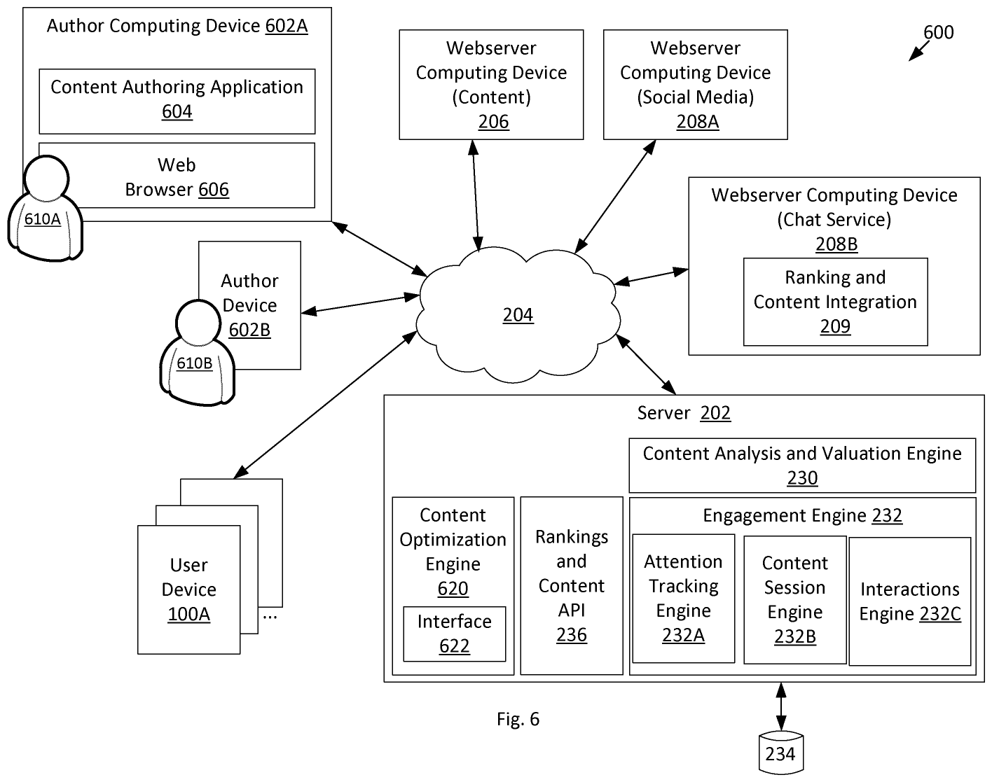

FIG. 6 is an illustration of a communication network system 600 in accordance with an embodiment. System 600 is similar to system 200 and further comprises author computing devices 602A and 602B used by respective author's 610A and 610B. In a respective embodiment, author computing device 602A comprises a content authoring component 604 with which to author instances of author content (not shown) and a web browser 606. In an example, content authoring component 604 comprises a plurality of sub components or related components to define content instances comprising one or more sub items (media, text, etc.) and to communicate same such as to webserver 206 for distribution. In an example, the component 604 includes an application to author a web page. Web browser 606 provides an interface to present content instances. In an embodiment web browser 606 provides an interface (which can be web-based) to upload an author's content instance to server 202 for analysis to receive an optimized content. Such may be communicated in a bundle including content sub items linked within the author's content if not available to server 202 (e.g. if not publicly available over network 204 via hyperlink, etc.)

Server 202 is configured with a content optimization engine 620, for example, including an interface 622 to receive author content and provide optimized results communicating with respective devices 602A and 602B to receive and reply. Device 602B can be similarly configured to device 602A. In an embodiment device 602B is configured to author content for an application based viewer. As further described content optimization engine 620 is enabled to use content analysis and validation engine 230 to generate attributes for the author's content instance received (e.g. via interface 622) and compare the attributes to aggregated granular attributed data for other content instances. Interface 622 can be configured to enable an author (e.g. 610A) via device 602A to select data for comparison, for example, setting relevant filters. In an embodiment the interface is a web interface providing GUI controls for an author and a control to upload an instance of new content.

All pieces of previously analyzed content having stored content attribute data and associated stored interaction attribute data that the author wishes to compare against have their respective data retrieved from data store 234. The respective data refers to all applicable content analysis and tracking attribute data (from engines 230 and 232) that was stored to data store 234. This data is then tabulated and averaged. Attributes for a piece of content comprise data related to the sub-items and the content as a whole, where examples include average length of paragraphs, number of paragraphs, number of images in a piece, number of headings, dominant vocabulary complexity, dominant mood or sentiment, number of paragraphs between headings, number of questions in the text, number of quotes, ratio of images to text, etc. Interaction attribute data examples (e.g. as tabulated and averaged) include completion rate (e.g. average percent of the piece of content consumed by users), positive/negative reactions to the piece of content, sharing of the piece of content, average attention rates for interaction with the piece of content, etc. This is identified as the audience data for the content instances.

Relationships between content attribute data and interaction attribute data can be determined. For example, content can be selected based on desirable or undesirable characteristics. Content that is highly consumed (e.g. on average, more than 95% of the content was consumed by users viewing the content) can be selected. Or content that is most ignored while interacting (on average, less than 5% of the content was consumed by users viewing the content) can be selected. Similarly, content can be selected based on criteria such as reactions, sharing, average attention, or any logical combination of criteria (e.g. highly consumed and highly attentive consumption). Content can be selected (for audience data) based on other or additional basis such as subject, author, time period (e.g. of publication or interaction by users), etc.

Average or total counts of content attributes can be determined for the selected content such as to determine best practices or worst practices. Emulating best practices and/or avoiding worst practices can lead to maximizing a likelihood that new content will promote or result in desired interaction with the content—which may comprise any one or more of: more complete consumption, more focused attention when consuming, more positive reactions, more shares, etc. Adapting content to have content attributes associated with desired interaction (e.g. associated to user behaviours) optimizes the content.

In an embodiment, content optimization engine 620 compares the author's content attributes for the instance of new content with the audience data and presents the differences, for example, annotating the author's content with suggestions.

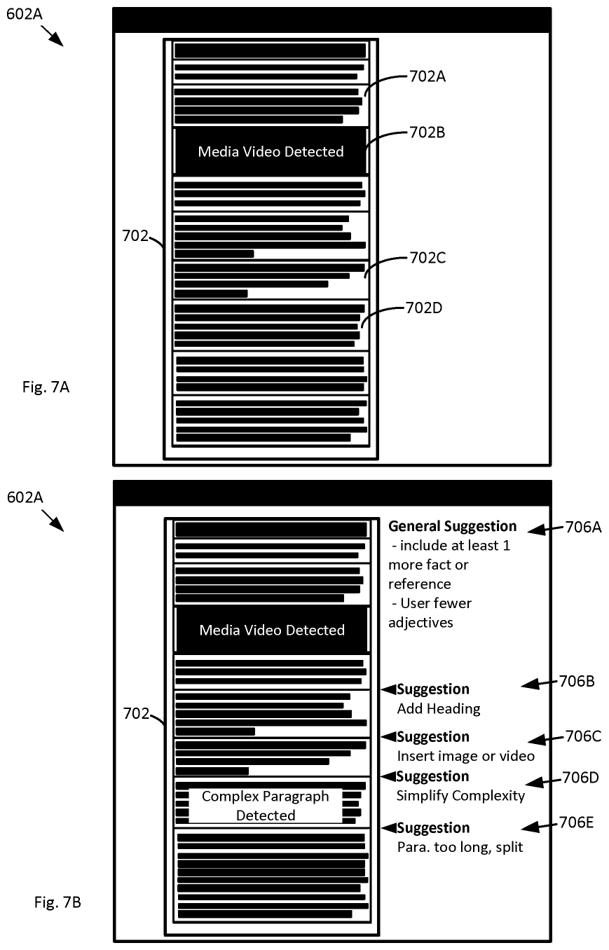

FIGS. 7A and 7B are respective illustrations of an author computing device e.g. 602A at different points in time where FIG. 7A shows author content 702 to be analyzed for optimisation and FIG. 7B shows analyzed content including annotation providing suggestions. Content 702 comprises a plurality of content sub items, such as but not limited to, sub items 702A, 702B, 702C and 702D. Sub item 702B is a media type while sub item 702D is a complex paragraph of text having complex structure, as an example.

In FIG. 7B, device 602 presents annotated author content 702 where, following an analysis and annotation by server 202, author content 702 is associated with a plurality of suggestions comprising a general suggestion 706A regarding the content as a whole, and specific sub item suggestions 706B, 706C, 706D and 706E relative to specific sub items. In the example, the general suggestion includes a reference to add more content (a fact or reference) and to change a content attribute (reduce a count of adjectives). Specific suggestions relate to:
adding specific content at a specific location such as adding a heading and inserting an image or video; and
revising content structure such as simplifying a complex paragraph or splitting a long paragraph.

Other general or specific sub-item suggestions can relate to tone, inserting more questions, increasing sentence length variability, etc.

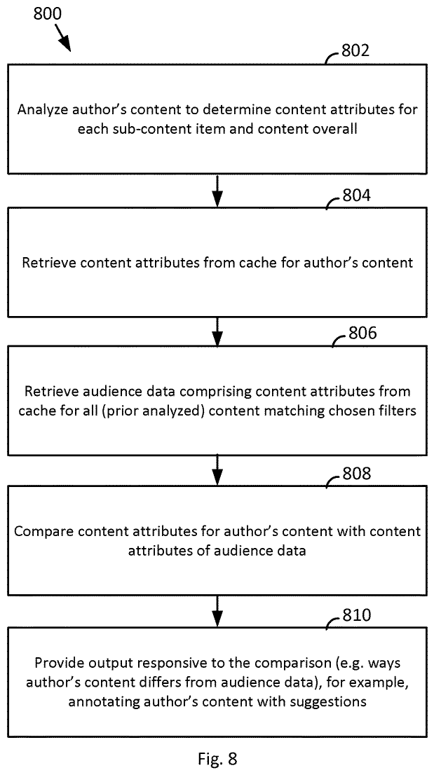

FIG. 8 is a flowchart of operations of a method in accordance with an embodiment. Operations 800 are performed by content optimization engine 620, in an embodiment. At 802 author's new content (such as received via interface 622) is analyzed to determine content attributes for each content sub-item and the content overall. The content is analyzed such as described with reference to FIG. 4B. At 804 the content attributes are retrieved or otherwise obtained from the attribute cache. At 806, audience data comprising content attributes are retrieved or otherwise obtained from the cache for all content matching chosen filters. Though not shown, in an embodiment, the author can set filters with applicable data values to select at least some of the previously analyzed content that is associated with interaction by users, which previously analyzed content may have originated from the author or from other authors (or both). The content can be selected based on desirable or undesirable characteristics.

At 808 the author's content attributes are compared to content attributes of the audience data. At 810 output is provided responsive to the comparison showing, for example, ways that the author's content differs from audience data. The author's content can be annotated such as shown in FIG. 7B.

Thus, in an embodiment, where content attribute data and interaction attribute data has been stored (e.g. in association) for respective user interactions with a plurality of content that was previously analyzed and had interactions tracked, an interface can be provided to receive new content, where the new content comprises a plurality of sub-content items. The new content can be analyzed to determine and store content attribute data for the new content. Operations can be performed to optimize the new content to maximize a likelihood of a desired interaction with the new content, the optimizing responsive to content attribute data of at least some of the plurality of content and the interaction attribute data associated therewith (e.g. audience data). In an embodiment, optimizing comprises providing changes to at least some content attributes of the new content. In an embodiment, the new content is annotated with the changes. In an embodiment, the at least some of the plurality of content (e.g. for the audience data) are selected from the plurality of content previously analyzed and tracked based on the associated interactive attribute data that maximizes the desired interaction.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A method comprising:
a) analyzing content for presentation by a computing device to a user, the content comprising a plurality of sub-content items, the analyzing determining, for each sub-content item, an item minimal duration for presentation;
b) determining from tracking data, for each of the sub-content items, an actual presentation duration and a focus measure of attention, wherein the tracking data is generated in response to user interactivity with the computing device during presentation of the content and the tracking data comprises content positional data and interactions with the content from inputs received;
c) computing a rating determined at least in part by the focus measure, the actual presentation duration, and the item minimal duration; and
d) providing the rating for display.

2. The method of claim 1, wherein item minimal duration comprises an amount of time required by an ordinary person to consume the respective sub-content item using a focused attention, based on an amount and nature of information in the sub-content item; and wherein the rating shows likely knowledge of the user in relation to verified consumption of the content.

3. The method of claim 1 or claim 2, comprising:
determining a subject for the content;
associating the rating with the subject; and
providing the subject for display with the rating.

4. The method of claim 3 comprising accumulating the rating with past ratings associated with the subject to determine a ranking for the subject and providing the ranking for display.

5. The method of claim 4, wherein at least one of the rating, past ratings and ranking are stored in association with the user and wherein the method comprises providing an interface to verify the at least one of the rating, past ratings and ranking of the user.

6. The method of any one of claims 4 to 5, comprising providing the ranking to share via social media or other making available to another, the ranking associated, when shared, with a link to the interface to verify the ranking of the user.

7. The method of any one of claims 4 to 6, comprising at least one of:
associating a reward to the rating and providing a service according to the reward; and
associating a reward to the ranking and providing a service according to the reward.

8. The method of any one of claims 1 to 7, wherein step a) comprises processing the sub-content items by data type to determine the item minimal duration.

9. The method of claim 8, wherein:
for a video or audio data type, processing comprises determining a play back length and applying a video or audio factor to the length to determine the item minimal duration;
for an image data type, processing comprises using image processing to determine whether the image is an infographic, comprising text and processing the text as a text data type; and
for a text data type, processing comprises determine text length, text complexity, and optionally any of text sentiment and text bias and applying one or more text factors to determine the item minimal duration.

10. The method of any one of claims 1 to 9 comprising receiving the tracking data, the tracking data defined during a presentation of the content via a display device to the user.

11. The method of claim 10, wherein defining the tracking data comprises logging the tracking data periodically.

12. The method of any one of claims 1 to 11, wherein:
tracking data comprises logged data for: i) the viewport; and ii) any interactivity in the viewport; wherein the logged data is associated with a timestamp; and
determining a focus measure comprises determining which sub-content item is presented in the viewport and a behavioral measure associated with a scroll rate for the sub-content item presented in the viewport.

13. The method of any one of claims 1 to 12, wherein:
when the content is presented in at least two separate sessions either by the same computing device or a different computing device:
step b) is performed for respective tracking data for each separate session responsive to a setup of the computing device used for the separate session; and
step c) determines a partial rating for the first session and adds to the partial rating for each separate session.

14. The method of any one of claims 1 to 13, wherein step b) uses setup data of the computing device with which to determine that a particular one of the sub-content items is actually presented and the actual presentation duration thereof.

15. The method of any one of claims 1 to 14 comprising processing the content to verify the content is valid prior to performing steps a) to d).

16. The method of any one of claims 1 to 15 comprising:
determining a content contribution by the user related with the content;
defining a content contribution rating responsive to the content contribution; and
providing the content contribution rating for display.

17. The method of claim 16 comprising:
following a making available of the content contribution to a recipient:
evaluating recipient interaction to the content contribution; and
defining a content contribution rating or an update thereto responsive to the evaluating.

18. The method of claim 17, wherein the contribution is made available in association with the user's subject ranking and/or an interface to validate any of the subject ranking and content contribution rating of the user.

19. The method of any one of claims 16 to 18, wherein a content contribution in association with the content comprises, by the user, any of:
recommending; reacting; commenting; adding to a collection of content; sharing; adding notes; and writing a summary.

20. The method of any one of claims 1 to 19, wherein content comprises any of a web page or an electronic document.

21. The method of any one of claims 1 to 20, wherein step a) determines for each sub-content item a credit value and wherein the rating is further determined in association with a total credit value of all sub-content items.

22. The method of any one of claims 1 to 21, comprising:
performing steps a) to d) for a plurality of content and respective interactions with the plurality of content by respective users;
storing content attribute data for each content of the plurality; and
for each user interacting with respective ones of the content, storing, in association with the content attribute data, interaction attribute data for each interaction.

23. The method of claim 22 comprising providing an interface to obtain insight data responsive to the content attribute data and interaction attribute data.

24. The method of claim 23, wherein the insight data is for a particular user based on the particular user's interaction with the content.

25. The method of claim 24, wherein the insight data provides a comparison to insight data for an aggregate of interactions with the content by a plurality of users.

26. The method of claim 24 or 25, wherein the insight data is in the form of trend data for a period of time.

27. The method of any one of claims 22 to 26, comprising:
providing an interface to receive a new content, the new content comprising a plurality of sub-content items;
analysing the new content to determine and store content attribute data for the new content; and
optimizing the new content to maximize a likelihood of a desired interaction with the new content, the optimizing responsive to content attribute data of at least some of the plurality of content and the interaction attribute data associated therewith.

28. The method of claim 27, wherein optimizing comprises providing changes to at least some content attributes of the new content.

29. The method of claim 28 comprising annotating the new content with the changes.

30. The method of any one of claims 27 to 29, wherein the at least some of the plurality of content are selected from the plurality of content based on the associated interactive attribute data that maximizes the desired interaction.

31. A computing device comprising a processor and a storage device storing computer readable instruction, which when executed by the processor cause the computing device to perform a method of any one of claims 1 to 30.

32. One or more non-transitory computer readable media storing instructions configured to, when executed, cause a computing device to perform a method of any one of claims 1 to 30.
